(19) United States
(12) Patent Application Publication
(10) Pub. No.: US 2006/0067849 A1
(43) Pub. Date: Mar. 30, 2006

(54) Rotor structure of inscribed gear pump

(75) Inventors: Ichiro Kimura, Nagoya-si (JP); Hiroyuki Kurokawa, Aichi-gun (JP)

Correspondence Address: REED SMITH LLP, Suite 1400, 3110 Fairview Park Drive, Falls Church, VA, 22042, US

(73) Assignee: Aisin Seiki Kabushiki Kaisha

(21) Appl. No.: 11/236,821

(22) Filed: Sep. 28, 2005

(30) Foreign Application Priority Data
Sep. 28, 2004 (JP) 2004-281843
Sep. 16, 2005 (JP) 2005-269894

(51) Int. Cl. F01C 1/02; F16N 13/20; F01C 1/063; F04C 2/00

(52) U.S. Cl. 418/61.3

(57) ABSTRACT

An inscribed gear rotor includes a housing forming a cylindrical space, a driven rotor including a plurality of inner gears, a driving rotor including a plurality of outer gears engaging with the respective inner gears, a plurality of interspaces formed between the inner gears of the driven rotor and the outer gears of the driving rotor respectively, a volume of each of the interspaces being increased and decreased so as to complete one cycle in a rotation for the purposes of performing an intake and a discharge of fluid, an inlet port being in communication with the cylindrical space, an outlet port being in communication with the cylindrical space, and a groove formed on a side face of the driving rotor and being in communication with the inlet port and the at least one of the interspace.

### CROSS REFERENCE TO RELATED APPLICATIONS

This application is based on and claims priority under 35 U.S.C. § 119 to Japanese Patent Application Nos. 2004-281843 and 2005-269894, filed on Sep. 28, 2004 and Sep. 16, 2005 respectively, the entire content of which is incorporated herein by reference.

### FIELD OF THE INVENTION

This invention generally relates to a rotor structure of an inscribed gear pump.

### BACKGROUND

In cases where a known inscribed gear pump widely used for an oil pump for a vehicle is utilized at a high rotational speed and then a suction speed of fluid is increased, suction of fluid in response to the rotational speed may not be achieved because of viscous resistance. Then, cavitation may be induced in an inlet passage (i.e. an inlet port and a space defined between rotor gears). The occurrence of cavitation may cause decrease of a pump volumetric efficiency, occurrence of abnormal noise, erosion inside of the pump, and the like.

In order to avoid such an issue, according to an inscribed gear pump disclosed in JP1989-83874A, a blocking portion for blocking between an inlet port and an outlet port is formed at a position of a space arranged next to a space having a maximum capacity and also in front thereof in a rotational direction. That is, a shape of the port is determined so as to adopt the aforementioned issue.

However, such a structure is effective against cavitation generated within an inlet port only and not effective against cavitation occurring in a space between rotor gears.

Meanwhile, according to an inscribed gear pump disclosed in JP1997-296716A, a groove or a chamfering is formed on a side face of a driving rotor so that adjacent spaces are in communication with each other for the purposes of easing sudden pressure fluctuation and preventing cavitation.

According to such a rotor structure of the inscribed gear pump described, an occurrence of cavitation may be limited to some extent but there is no effect against an excess suction speed of fluid, which is a fundamental cause of cavitation. Thus, a sufficient effect may not be obtained.

Further, according to an inscribed gear pump disclosed in JP1994-117379A, a groove that opens in a rotational direction is formed on a side face of a driving rotor or a driven rotor.

According to such a rotor structure, however, fluid is introduced to a gap formed between a sidewall of a rotor chamber and the side face of the driving rotor or the driven rotor for the purposes of reducing contact resistance between each rotor and the rotor chamber. Thus, no effectiveness may be obtained for preventing cavitation from occurring in a space between the rotor gears.

Thus, a need exists for a rotor structure of an inscribed gear pump thereby limiting an occurrence of cavitation in a space defined between rotor gears.

### SUMMARY OF THE INVENTION

According to an aspect of the present invention, an inscribed gear pump includes a housing forming a cylindrical space, a driven rotor rotatably arranged in the cylindrical space and including a plurality of inner gears, a driving rotor rotatably arranged in the driven rotor and including a plurality of outer gears engaging with the respective inner gears, a plurality of interspaces formed between the inner gears of the driven rotor and the outer gears of the driving rotor respectively, a volume of each of the interspaces being increased and decreased so as to complete one cycle in a rotation for the purposes of performing an intake and a discharge of fluid, an inlet port being in communication with the cylindrical space, an outlet port being in communication with the cylindrical space, and a groove formed on a side face of the driving rotor and being in communication with the inlet port and the at least one of the interspaces. The groove extends toward a gear bottom portion formed between the adjacent outer gears and extends in a radial direction of the driving rotor.

### BRIEF DESCRIPTION OF THE DRAWINGS

The foregoing and additional features and characteristics of the present invention will become more apparent from the following detailed description considered with reference to the accompanying drawings, wherein:

FIG. 1 is a backside view of a pump according to an embodiment of the present invention;

FIG. 2 is a perspective view showing an engagement state between a driven rotor and a driving rotor according to the embodiment of the present invention;

FIG. 3 is an enlarged view of a P portion of FIG. 2;

FIG. 4 is a plane view of the driven rotor according to the embodiment of the present invention;

FIG. 5 is a cross-sectional view taken along the line A-A of FIG. 4;

FIG. 6 is a cross-sectional view taken along the line B-B of FIG. 4;

FIG. 7 is a perspective view of a main portion of a groove according to the embodiment of the present invention;

FIG. 8 is a cross-sectional view showing a structural relationship among the driven rotor, the driving rotor, and an inlet port according to the embodiment of the present invention;

FIG. 9 is a cross-sectional view showing a structural relationship among a driven rotor, a driving rotor, and an inlet port according to a conventional pump;

FIG. 10 is a graph for comparing a pump volumetric efficiency in cases where the groove is formed or not formed;

FIG. 11 is a graph for comparing a pump driving horsepower in cases where the groove is formed or not formed; and

FIG. 12 is a cross-sectional view taken along the line A-A of FIG. 4 for showing a groove 550 according to another embodiment of the present invention.

### DETAILED DESCRIPTION

An embodiment of the present invention is explained with reference to the attached drawings.

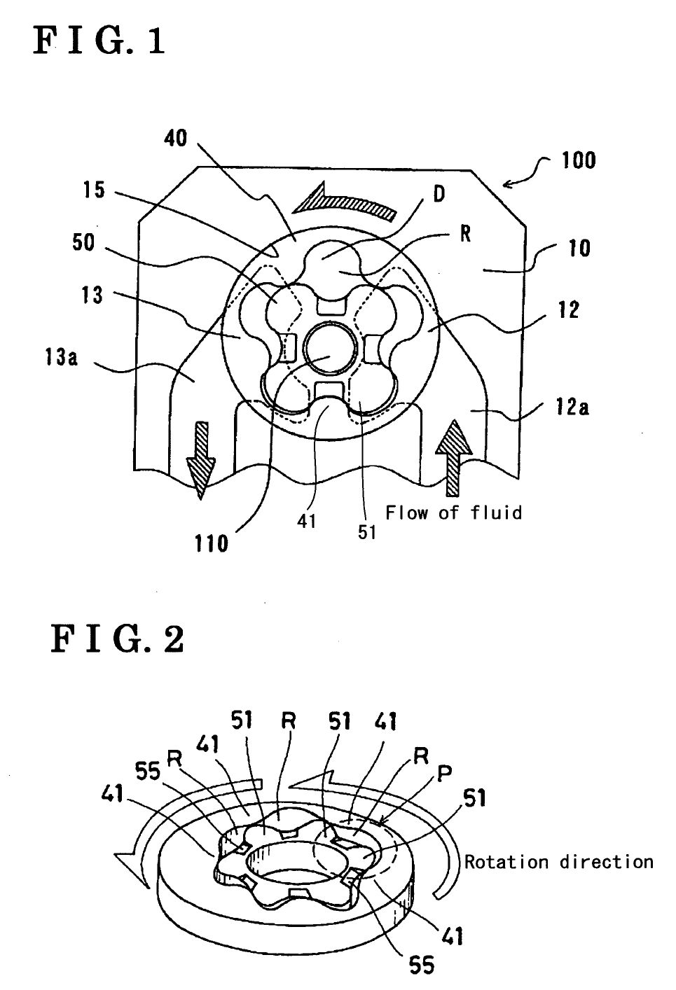

FIG. 1 is a backside view of a pump (i.e. inscribed gear pump) 100. The pump 100 mainly includes a body 10, a cover 20 (see FIG. 8), a driven rotor 40, a driving rotor 50, and a shaft 110 disposed into a center portion of the driving rotor 50 so as to drive the driving rotor 50. The body 10 and the cover 20 constitute a housing on which a rotor chamber 15 of a cylindrical space is formed. The rotor chamber 15 accommodates therein the driving rotor 50 into which the shaft 110 is disposed and the driven rotor 40 engaging with the driving rotor 50 in such a manner that the driven rotor 40 is off-centered relative to the driving rotor 50 by a predetermined amount. The driving rotor 50 and the driven rotor 40 engage with each other in such a manner that outer gears 51 of the driving rotor 50 and the inner gears 41 of the driven rotor 40 are respectively meshed with each other.

The driving rotor 50 is rotated by means of a driving force of the shaft 110. Then, the driven rotor 40 is rotated by means of an engagement with the driving rotor 50. Fluid is sucked into an inlet passage 12a via an inlet port 12 and discharged to an outlet passage 13a via an outlet port 13 when the driven rotor 40 and the driving rotor 50 rotate.

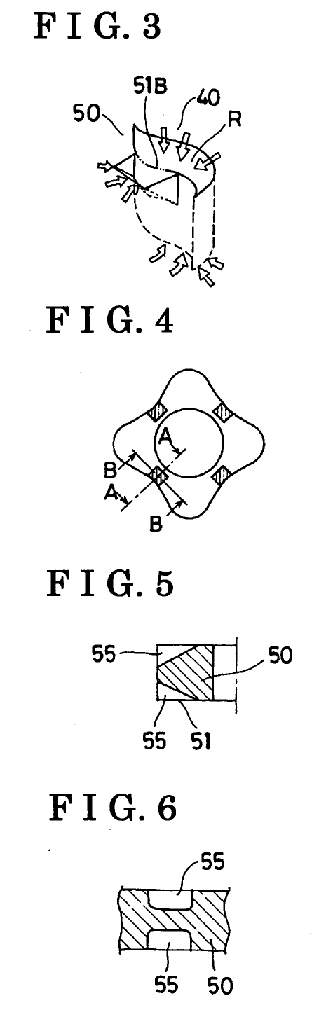

FIG. 2 is a perspective view showing an engagement state between the driven rotor 40 having the inner gears 41 and the driving rotor 50 having the outer gears 51 engaging with the respective inner gears 41. FIG. 3 is an enlarged view of a P portion in FIG. 2 for showing one of interspaces R formed by the adjacent inner gears 41 in contact with the respective outer gears 51.

As shown in FIGS. 1 and 2, when the driven rotor 40 and the driving rotor 50 rotate relative to the inlet port 12, volumes of the interspaces R are changed. That is, each of the interspaces R moves while the driving rotor 50 and the driven rotor 40 rotate, and the volume of each of the interspaces R is increased and decreased so as to complete one cycle in a rotation. The volume of the interspace R is gradually increased and finally maximized at a blocking position D provided between the inlet port 12 and the outlet port 13. Then, when the driven rotor 40 and the driving rotor 50 rotate from the blocking position D towards the outlet port 13, the volume of the interspace R is gradually decreased. Accordingly, the volume of each of the interspaces R is increased and decreased along with the rotation of the driven rotor 40 and the driving rotor 50 so as to perform an intake or a discharge of fluid via the inlet port 12 and the outlet port 13.

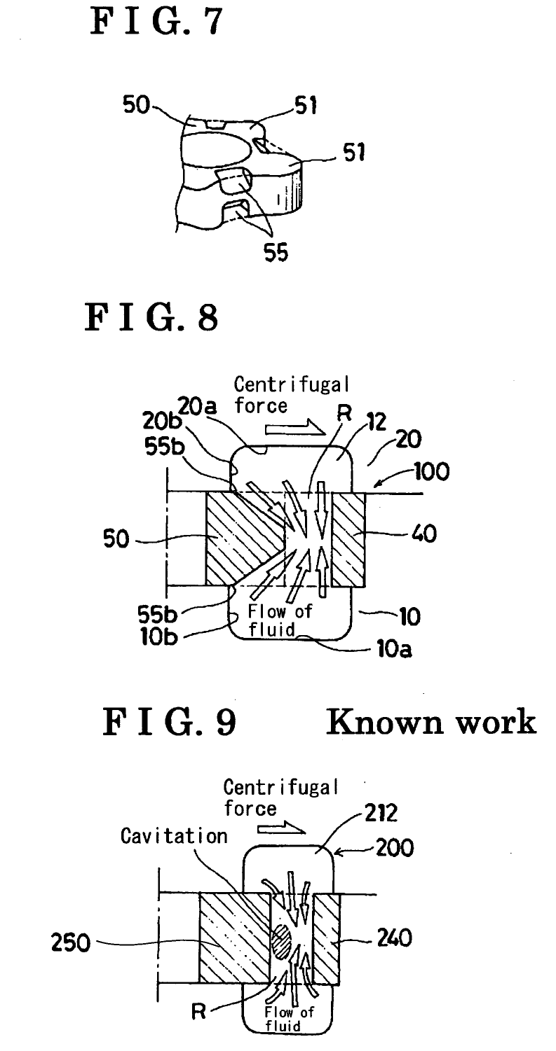

As shown in FIGS. 2 to 7, each groove 55 is formed on a side face, which is defined between the adjacent outer gears 51, of the driving rotor 50 and is in communication with the inlet port 12 and the interspace R. Further, each groove 55 extends toward a gear bottom portion 51B arranged between the adjacent outer gears 51 as shown in FIG. 7. The groove 55 extends in a radial direction as shown in FIG. 4. Further, the groove 55 inclines in a radially outer direction as viewed in a cross section that includes an axis of the driving rotor 50 as shown in FIG. 5. With this shape of the groove 55, fluid flowing through the groove 55 receives centrifugal force and then flows smoothly on the groove 55. Further, fluid may flow into a substantially center portion of the interspace R where a negative pressure is most likely to be generated. As shown in FIGS. 5 and 6, the groove 55 is formed so as to be symmetric with respect to a plane perpendicular to a rotational axis of the driving rotor 50 and including a midpoint in an axially width direction of the driving rotor 50. Thus, the driving rotor 50 may be assembled without considering a direction thereof, i.e. front side or back side, to the rotor chamber 15.

FIG. 8 is a cross-sectional view showing a structural relationship among the driven rotor 40, the driving rotor 50, and the inlet port 12. The inlet port 12 includes recess portions 10a and 20a respectively formed on the body 10 and the cover 20. The inlet port 12 is connected to the inlet passage 12a.

Respective portions of outlines 10b and 20b of the recess portions 10a and 20a, i.e. left end portion in FIG. 8, which form the inlet port 12, are arranged at a position substantially equal to a position where an inner peripheral end 55b of the groove 55, i.e. an end portion of the groove 55 on a radially center side, is provided. Thus, an opening area of the groove 55 relative to the inlet port 12 may be maximized, thereby increasing an amount of fluid flowing into the interspace R via the groove 55.

FIG. 9 is a cross-sectional view showing a structural relationship among a driven rotor 240, a driving rotor 250, and an inlet port 212 of a pump 200 not equipped with a groove according to a conventional inscribed gear pump. In this pump 200, fluid may not smoothly or massively flow into a substantially center portion of the interspace R. As a result, cavitation (shown by a shaded circle) may be easily generated around a center of a gear bottom portion between outer gears of the driving rotor 20.

Next, an operation of the present embodiment is explained below.

The pump 100 is rotated in such a manner that the driving rotor 50 rotated by a driving force of the shaft 110 and the driven rotor 40 engages with each other. Then, fluid is sucked into the inlet port 12 through the inlet passage 12a and then discharged to the outlet passage 13a via the outlet port 13. Fluid is then finally sent in a pressed manner to a fluid-fed portion.

At this time, a negative pressure is likely to be generated especially at a center of the interspace R formed between the driving rotor 50 and the driven rotor 40. However, the groove 55 is formed on a side face of the driving rotor 50 so as to extend toward the gear bottom portion 51B formed between the adjacent outer gears 51 in a radial direction. Thus, an opening area of the interspace R may be enlarged and at the same time fluid may flow into a substantially center portion of the interspace R by biasing fluid flowing through the groove 55 to the interspace R by means of centrifugal force. The negative pressure may be reduced and an occurrence of cavitation may be prevented.

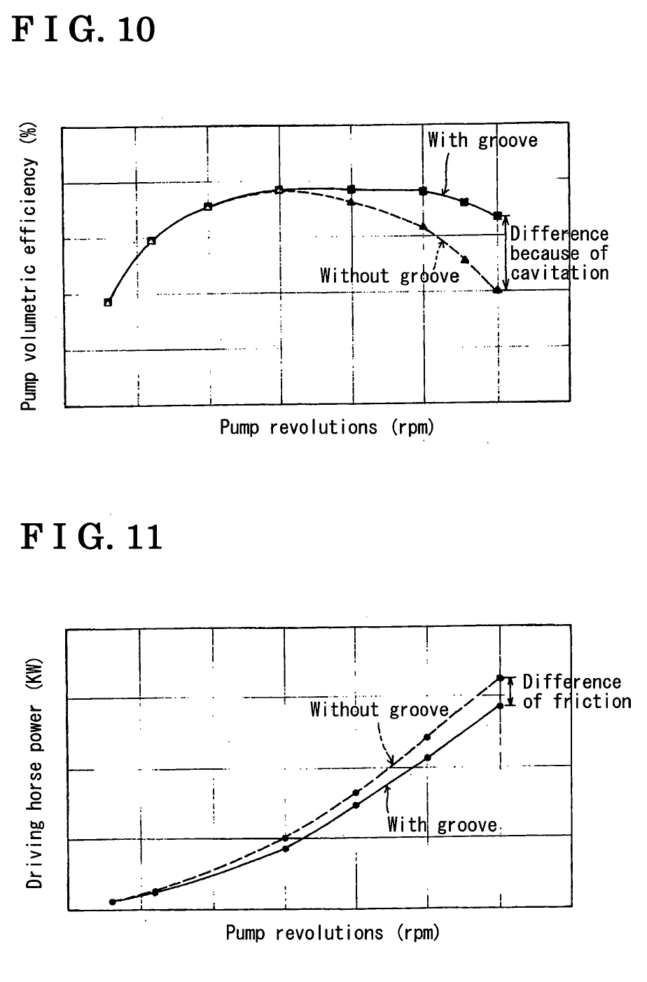

As shown in FIGS. 10 and 11, according to the present embodiment, a high pump volumetric efficiency is still achieved at a high rotational speed. Further, by providing the groove 55 on a side face of the driving rotor 50, a sliding resistance and an intake resistance may be reduced, thereby achieving a reduction of a pump friction and a driving power force.

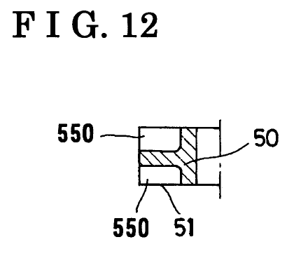

According to the aforementioned embodiment, the groove 55 inclines in a radially outer direction as viewed in a cross section that includes an axis of the driving rotor 50. Alternatively, as shown in FIG. 12, a groove 550 having an L-shape in the cross section that includes the axis of the driving rotor 50 is formed according to another embodiment. In such a case, an advantage equal to that of the aforementioned embodiment may be obtained. In addition, in case of manufacturing the driving rotor 50, molding of the groove 550 may be simplified at a time of metal sintering as a generally used manufacturing method. Further, uniformity of metallic density may lead to stabilization of quality.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. An inscribed gear pump comprising:
a housing forming a cylindrical space;
a driven rotor rotatably arranged in the cylindrical space and including a plurality of inner gears;
a driving rotor rotatably arranged in the driven rotor and including a plurality of outer gears engaging with the respective inner gears;
a plurality of interspaces formed between the inner gears of the driven rotor and the outer gears of the driving rotor respectively, a volume of each of the interspaces being increased and decreased so as to complete one cycle in a rotation for the purposes of performing an intake and a discharge of fluid;
an inlet port being in communication with the cylindrical space;
an outlet port being in communication with the cylindrical space; and
a groove formed on a side face of the driving rotor and being in communication with the inlet port and the at least one of the interspaces; the groove extending toward a gear bottom portion formed between the adjacent outer gears in a radial direction of the driving rotor.

2. An inscribed gear pump according to claim 1, wherein at least one portion of an outline of the inlet port formed in the housing is arranged at a position substantially equal to a position where an inner peripheral end of the groove is arranged.

3. An inscribed gear pump according to claim 2, wherein the housing includes an inner wall face that faces respective side faces of the driving rotor and the driven rotor, the inner wall face on which a recess portion is formed for defining the inlet port, and at least one portion of an outline of the recess portion is arranged at a position substantially equal to a position where an end portion of the groove on a radially center side is arranged.

4. An inscribed gear pump according to claim 1, wherein the groove inclines in a radially outer direction as viewed in a cross section that includes an axis of the driving rotor.

5. An inscribed gear pump according to claim 3, wherein the groove inclines in a radially outer direction as viewed in a cross section that includes an axis of the driving rotor.

6. An inscribed gear pump according to claim 1, wherein the groove forms into an L-shape as viewed in a cross section that includes an axis of the driving rotor.

7. An inscribed gear pump according to claim 3, wherein the groove forms into an L-shape as viewed in a cross section that includes an axis of the driving rotor.

8. An inscribed gear pump according to claim 1, wherein all the side faces each defined between the adjacent outer gears of the driving rotor are formed with the respective grooves.

9. An inscribed gear pump according to claim 5, wherein all the side faces each defined between the adjacent outer gears of the driving rotor are formed with the respective grooves.

10. An inscribed gear pump according to claim 7, wherein all the side faces each defined between the adjacent outer gears of the driving rotor are formed with the respective grooves.

11. An inscribed gear pump according to claim 1, wherein the grooves are formed on the side faces of the driving rotor in parallel with each other.

12. An inscribed gear pump according to claim 9, wherein the grooves are formed on the side faces of the driving rotor in parallel with each other.

13. An inscribed gear pump according to claim 10, wherein the grooves are formed on the side faces of the driving rotor in parallel with each other.

14. An inscribed gear pump according to claim 11, wherein each groove is formed on the side face of the driving rotor so as to be symmetric with respect to a plane perpendicular to a rotational axis of the driving rotor and including a midpoint in an axially width direction of the driving rotor.

15. An inscribed gear pump according to claim 12, wherein each groove is formed on the side face of the driving rotor so as to be symmetric with respect to a plane perpendicular to a rotational axis of the driving rotor and including a midpoint in an axially width direction of the driving rotor.

16. An inscribed gear pump according to claim 13, wherein each groove is formed on the side face of the driving rotor so as to be symmetric with respect to a plane perpendicular to a rotational axis of the driving rotor and including a midpoint in an axially width direction of the driving rotor.
